(19) United States
(12) Patent Application Publication
(10) Pub. No.: US 2004/0204558 A1
(43) Pub. Date: Oct. 14, 2004

(54) Energy curable adduct containing a silane group and coating therefrom

(76) Inventors: Adrian J. Birch, La Traviata (NL); Alan W. Duff, Lincolnshire (GB)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/475,508

(22) PCT Filed: May 7, 2002
(86) PCT No.: PCT/US02/14310

(30) Foreign Application Priority Data
May 7, 2001 (US) 60289211

(51) Int. Cl. C08G 18/00

(52) U.S. Cl. 528/44

(57) ABSTRACT

Disclosed is a polyfunctional liquid polyurethane-containing adduct wherein the adduct contains statistically as a first functional group at least one structo-terminal polymerizable group and at least one second structo-terminal functional group per molecule which is a silane moiety. Such compounds are useful in radiation curable coatings.

The present invention relates to compounds which contain both a polymerizable moiety and a silane moiety. Such compounds find use, as monomers or oligomers, as adhesion promoting coupling agents in free radically curable compositions, and radiation curable compositions containing such compounds.

Radiation curing is widely used in coatings, inks and adhesives. Radiation curing is popular as it provides low or zero volatile emission and allows high productivity. Radiation curable compositions are typically mixtures of monomers, oligomers, photoinitiators, and other additives, which are applied to the substrate and cured in place via ultraviolet light or electron beam radiation. Silane coupling agents have been widely used to improve adhesion in traditional coatings and composites based on epoxy chemistry.

In a first aspect, this invention is a polyfunctional liquid polyurethane-containing adduct wherein the adduct contains as a first functional group at least one structo-terminal polymerizable group and at least one second structo-terminal functional group per molecule which is a silane moiety.

In a second aspect this invention is an energy curable composition, suitable for coating a substrate which comprises a polyfunctional liquid polyurethane-containing adduct wherein the adduct contains as a first functional group at least one structo-terminal polymerizable group and at least one second structo-terminal functional group per molecule which is a silane moiety, and wherein said adduct is present in an amount of from 0.1 to 99 percent based on total weight of the composition.

In a third aspect this invention is to a process of coating a substrate surface that involves in a first step: applying to a surface of a substrate a composition which comprises a polyfunctional liquid polyurethane-containing adduct wherein the adduct contains as a first functional group at least one structo-terminal polymerizable group and at least one second structo-terminal functional group per molecule which is a silane moiety, and wherein said adduct is present in an amount of from 0.1 to 99 percent based on total weight of the composition; and in a second step, exposing said treated surface to an energy source that can induce polymerization of the composition.

In a fourth aspect, this invention is to an article which comprises a substrate that has adhered to one of its surfaces a polymeric film wherein said article is obtained by the process as above mentioned.

The silane adducts of the present invention give improved compatibility of silane agents in energy cured formulations. Such crosslinkable adducts have a reduced tendency of component separation in energy-curable formulations and therefore reduced migration issues. The reduced migration, particularly of the silane, is a result of the silane and polymerizable groups being linked to one molecule and once a functional group is polymerized into the polymer matrix, the other functional group is also fixed. Formulations using the present adducts are also useful for reducing the surface free energy of coating formulations and improving adhesion to substrates, especially inorganic substrates such as metal and glass. The adducts also provide techniques for dual cure crosslinking of energy cured systems (moisture cure of silane groups in addition to energy cure) giving three dimensional polymer inter-connectivity, leading to higher overall crosslink density.

The adduct of this invention is characterized in that it is a polyfunctional liquid polyurethane adduct bearing energy polymerizable groups and a second different functional group which is a silane moiety. By the term “liquid” it is meant that the adduct has a pour point of 50° C. or less, and preferably is a liquid at a temperature of from 0° C. to 40° C.

The polyfunctional liquid polyurethane-containing adduct has a polyol core which is extended with an isocyanate moiety and terminated with at least two functional groups. These functional groups are structo-terminal, that is, they are not pendent, that is, not hanging or branching from the backbone. Statistically, within the same adduct molecule, at least one chain end bears a polymerizable group, and at least one chain end bears a silane group.

By the term “polymerizable group” it is understood a moiety that is susceptible to polymerization when exposed to an energy source, optionally in the presence of an initiator. Such energy sources can be, for example, actinic radiation, ultraviolet or electron-beam radiation, or thermal radiation.

By the term “silane” group or moiety, it is meant a silane which also contains a single isocyanate reactive group for example, secondary amine, mercapto or epoxy. In addition such molecules contain one, two or three hydrolyzable groups on the silicon. Examples of such hydrolyzable groups include hydrogen, alkoxy, acyloxy, halogen, and oxine. The alkoxy group is the preferred hydrolyzable group. Such silane moieties can be represented by the general formula

G-R²SiY¹Y²Y³;

where G is HS—, epoxy or

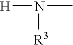

R² at each occurrence is independently a divalent linking group having 1 to 8 carbon atoms, which can contain heteroatoms, particularly oxygen;

R³ is a C₁-C₂₀ organic group or R²SiY¹Y²Y³;

Y¹, Y² and Y³ at each occurrence may be the same or different, and represent alkoxyl, carboxy, alkoxy ether, alkyl or aryl; with the proviso that at least one of Y¹, Y² or Y³ is a silane group which can undergo moisture cure, such as an alkoxyl. Preferably Y¹, Y² or Y³ will contain from 1 to 4 carbon atoms. When an alkoxy group, preferably Y¹, Y², Y³ are methoxy, ethoxy, acetoxy, methoxyethoxy or a mixture thereof. Representative examples of R² include propyl, butyl, pentyl, or hexyl group. Preferably G is a secondary amine as represented above.

Examples of the silanes are bis-(gamma-trimethoxysilylpropyl)amine, N-phenyl-gamma-aminopropyltrimethoxysilane, gamma-mercaptopropyltrimethoxysilane, N-(n-butyl)-3-aminopropyltrimethoxysilane, gamma-glycidoxypropyltrimethoxysilane.

Following hydrolysis of some of the terminal silyl groups, the polymers are curable by mutual interreaction to form siloxane linkages.

In a preferred embodiment of this invention, the adduct has an average of from 2 to 8, more preferably from 3 to 8, and yet more preferably from greater than 3 to 6 chain ends per molecule, wherein each chain contains one or more urethane linkages. When the adduct contains from 2 to 8 chain ends per molecule; in the case of 8 then from 1 to 7 energy polymerizable moieties per molecule and from 7 to 1 silane moieties are present, and in the case of 2 end groups per molecule, statistically 1 energy polymerizable moiety and 1 silane moiety are present. The optimum ratio of polymerizable moieties to silane moieties will depend on the intended purpose and surface to be coated and can vary within the ranges of from 1:7 to 7:1, and preferably from 1:2 to 2:1.

By chain ends implies the silane moieties will be structo-terminal. For a polyol having a functionality of 2, this can be represented by

Z-X²-ISO-X¹-POLYOL-X¹-ISO-X²-Z;

X¹ represents the divalent radical formed between an isocyanate and the isocyanate reactive moiety of the polyol;

where X² represents the divalent radical formed between an isocyanate and the isocyanate reactive moiety of G-R²SiY¹Y²Y³ or the isocyanate reactive moiety of a polymerizable compound;

ISO represents a moiety derived from a polyisocyanate component having 2 isocyanate reactive groups;

POLYOL represents a moiety derived from a polyol component comprising a compound having 2 isocyanate reactive functional group, such a polyol can have more than 2 isocyanate reactive functional groups as described herein;

Z represents a moiety derived from G-R²SiY¹Y²Y³ having at least one isocyanate reactive groups or a polymerizable group, where G-R²SiY¹Y²Y³ is as defined above.

The polyfunctional liquid polyurethanes adducts of the present invention can contain additional functional moieties such as an aryl, alkyl, ester, nitrile, alkene, alkyne, halogen, silyl or combinations thereof. The equivalents of polymerizable and silane moieties and optionally additional functional groups is such that the adduct is substantially free of any isocyanate functionality or any isocyanate-reactive functionality.

The adducts of the invention are prepared by reaction of an isocyanate-terminated prepolymer with substances containing the polymerizable group and with substances containing the silane moiety. An isocyanate-terminated prepolymer is generally prepared by reacting an excess of an isocyanate with an isocyanate-reactive compound. Materials and processes are described in more detail hereinafter.

The isocyanates which may be used in producing a prepolymer include aliphatic, cycloaliphatic, arylaliphatic and aromatic isocyanates. Advantageously the isocyanates selected are those which have the ability to be removed from crude mixtures through distillation or solvent extraction procedures. Preferred are aromatic and aliphatic polyisocyanates and notably diisocyanates. Such aromatic and aliphatic isocyanates may also be used in admixture when preparing a prepolymer.

Examples of suitable aromatic isocyanates include the 4,4′-, 2,4′ and 2,2′-isomers of diphenyhnethane diisocyante (MDI), blends thereof and polymeric and monomeric MDI blends, toluene-2,4- and 2,6-diisocyanates (IDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether. A preferred isocyanate is toluene-2,4- and 2,6-diisocyanates (TDI).

Examples of suitable aliphatic polyisocyanates include ethylene diisocyanate, 1,6-hexamethylene diisocyanate, 1,4-tetramethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

Isocyanate-reactive compounds useful in the preparation of the prepolymer include substances bearing a plurality of isocyanate-reactive functional groups per molecule where such functional groups include —OH, —SH, —COOH, —NM, where R is not reactive towards isocyanate groups, such as an aryl, alkyl, ester, nitrile, alkene, alkyne, halogen, silyl, preferably a C1 to C6 alkyl. Preferred is when such isocyanate reactive functional group is —OH functional. Typically such isocyanate-reactive materials are collectively referred to as a polyol. The polyol may contain up to 8 such functional groups per molecule, preferably from 2 to 8, more preferably from 3 to 8, and most preferably from greater than 3 to 6 functional groups per molecule. Advantageously the polyol is a polyether polyol, also known as a polyoxyalkylene polyol. Other polyols include polyester polyols, polycaprolactone polyols, polyalkylene carbonate polyols, polyolefinic polyols and polyphosphate-based polyols. Such polyols are known in the art

The polyol generally has an equivalent weight of from 100 to 5000. Preferably the polyol has an equivalent weight of from 200 or greater, more preferably from 300 or greater. Preferably the equivalent weight is less than 3000, more preferably less than 2000, and yet more preferably less than 1500. Preferably the polyol is a polyester or polyether polyol. Highly preferred are polyoxyalkylene polyols where the oxyalkylene entity comprises oxyethylene, oxypropylene, oxybutylene or mixtures of two or more thereof. Especially preferred are oxypropylene or oxyethylene or mixtures thereof. More especially preferred is oxypropylene. Processes for making such polyols are known to those in the art.

Suitable polyoxyalkylene polyols are exemplified by various commercially available polyols as used in polyurethane, lubricant, surfactancy applications and include polyoxypropylene glycols designated as VORANOL™ P-2000 and P4000 with respectively equivalent weights of 1000 and 2000; polyoxypropylene-oxyethylene glycols such as DOWFAX™ DM-30 understood to have an equivalent weight of 300 and an oxyethylene content of 65 weight percent, and SYNALOX™ 25D-700 understood to have an equivalent weight of 2750 and an oxyethylene content of 65 weight percent, all available from The Dow Chemical Company; polyoxyethylene triols available under the trademark TERRALOX™ and designated as product WG-98 and WG-116 understood to have a molecular weight of 700 and 980, respectively, polyoxypropylene-oxyethylene triols designated as VORANOL™ CP 1000 and CP 3055 understood to have respectively a molecular weight of 1000 and 3000, and VORANOL™ CP 3001 understood to have a molecular weight of 3000 and an oxyethylene content of 10 weight percent and VORANOL™ CP 6001 understood to have a molecular weight of 6000 and an oxyethylene content of 15 weight percent, all available from The Dow Chemical Company; poly(oxypropylene-oxyethylene) hexols including VORALUX™ HF 505 understood to have a molecular weight of 12000, and polyoxyethylene hexols including TERRALOX™ HP400 understood to have a molecular weight of 975, both available from The Dow Chemical Company; higher functionality polyether polyols including those based on carbohydrate initiators such as, for example, sucrose and exemplified by VORANOL™ 370 available from The Dow Chemical Company. Some of the above polyols have been described by reference to their molecular weight and whether they are difunctional (diol) or trifunctional (triol) and so forth. The equivalent weight of such substances is generally understood as being the numerical result of the molecular weight divided by the nominal functionality.

The isocyanate-terminated prepolymer is generally prepared by the reaction of an excess of polyisocyanate with the polyol under standard conditions known in the art. The polyisocyanate is added at an excess to provide an NCO:OH ratio of greater than 2:1 to 20:1. Preferably the NCO:OH ratio is 2.5:1 to 10:1. Most preferably ratio is 3.2:1 to 8:1. The unreacted isocyanate monomer is removed from the prepolymer by distillation or other treatment to a concentration of less than 3 percent, preferably less than 1 percent, more preferably less than 0.5 percent, and yet more preferably less than 0.1 percent by weight of unreacted polyisocyanate in the prepolymer. The temperatures for effecting reaction between the polyisocyanate and polyol are generally 0° C. to 120° C.

To facilitate the formation of the urethane bond between the isocyanate and polyol, a catalyst may be used. Such catalysts are known in the art and include tertiary amine compounds, amines with isocyanate reactive groups and organometallic compounds.

Alternatively the polyol can be added to the polyisocyanate at a controlled rate, as disclosed in WO 96/34904, the disclosure of which is incorporated herein by reference, to produce prepolymers having a low residual free isocyanate monomer. This controlled addition is done under essentially anhydrous conditions, in the absence of a catalyst, and maintained temperature of from 20° C. to 80° C.

The preparation of prepolymers as described above reduces the formation of higher oligomers or polyol terminated prepolymers. The formation of oligomers rapidly increases the functionality and viscosity of the prepolymer and can lead to gelation. See for example, WO 96/34904, which describes the formation of oligomers. The prepolymers of the invention are characterized in that they have a theoretical isocyanate content of from 1 to 16, preferably from 1 to 10, more preferably from 1 to 7 weight percent. Measured isocyanate contents may be higher depending on residual content of unreacted polyisocyanate.

The so obtained isocyanate-terminated prepolymer is reacted with isocyanate-reactive substances containing the polymerizable group and with isocyanate-reactive substances containing the silane moiety.

Isocyanate-reactive substances containing the silane moiety are described above.

Isocyanate-reactive substances containing the polymerizable moiety are substances which contain a functional group that can polymerize under the influence of an energy source and which additionally contain a functional group that can react with an isocyanate such as described above. The isocyanate reactive substance could also be an isocyanate if it is the intention to couple to the prepolymer by formation of an isocyanurate or carbodiimide linkage.

One type of radiation polymerizable functionality is ethylenic unsaturation which in general is polymerized through radical polymerization such as can be initiated through exposure to actinic radiation, but can also be polymerized through cationic or anionic polymerization. Examples of ethylenic unsaturation are groups containing vinylether, vinyl ester (for example, acrylate or methacrylate) or acrylamide functionality. Preferably, the polymerizable group is a vinyl ester group or a vinylether group. Most preferably, the polymerizable group is an acrylate or methacrylate group.

The polymerizable vinyl ester can be represented by the following formula:

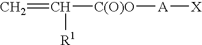

and the vinyl ether can be represented by the formula

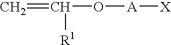

where X is an isocyanate-reactive functional group, such as —OH, —SH, —COOH or

—NHR where R is as previously defined; R¹ is a substituent comprising hydrogen, a C1 to C3 alkyl or acyl radical or a halogen or other group which will not deleteriously affect the curing of the finished adduct, and A is an aliphatic or aromatic hydrocarbon segment have 1 to 6 carbon atoms. As it is desirable to have a final product which is a liquid, A and R¹ are selected to give a final product which is a liquid.

Hydroxy functional ethylenically unsaturated monomers are preferred. Preferably A is a C1 to C4 alkyl. More preferably A is a C2 alkyl. Preferably the unsaturated monomer contains vinyl ester, vinyl ether, maleate or fumarate functionality.

Examples of the (meth)acrylate having a hydroxyl group used in the present invention include hydroxyethyl acrylate, 2-hydroxyethyl(meth)acrylate, 2-hydroxypropyl (meth)acrylate, 2-hydroxybutyl (meth)acrylate, 2-hydroxy-3-phenoxypropyl (meth)acrylate, 1,4-butanediol mono (meth)acrylate, 2-hydroxyalkyl (meth) acryloyl phosphate, 4-hydroxycyclohexy (meth)acrylate, 1,6-hexanediol mono(meth)acrylate, neopentyl glycol mono(meth)acrylate, trimethylolpropane di(meth)acrylate, trimethylolethane di(meth)acrylate and such like. Among these (meth) acrylates preferred are 2-hydroxyethyl acrylate, 2-hydroxypropyl acrylate, 2-hydroxyethyl methacrylate, 2-hydroxypropyl methacrylate, diethylene glycol monoacrylate, diethylene glycol monomethacrylate, glycerine dimethacrylate, dimethylol propane dimethacrylate, and reaction products of polyester glycols with acrylic or methacrylic acid. Such compounds are commercially available or can be produced using standard procedures known in the art.

Monomers having vinyl ether functional groups include, for example, 4-hydroxybutyl vinyl ether and triethylene glycol monovinyl ether. Monomers having maleate functional groups include, for example, maleic acid and hydroxy functional maleates.

The above mentioned isocyanate-reactive substances containing the polymerizable moiety can be also used as a mixture wherein said mixture comprises a blend of two or more such substances.

The adduct of this invention is obtained by capping reaction of the isocyanate-terminated prepolymer with less than a stoichiometric equivalent of the isocyanate-reactive substance containing the polymerizable moiety and with a slight stoichiometric excess of the isocyanate-reactive substance containing the silane moiety in relation to the remaining unreacted isocyanate moieties. The stoichiometry is such to provide for the desired content of moieties. This reaction is generally conducted in a sequential manner with the isocyanate-reactive material containing the polymerizable moiety being first reacted with the prepolymer and then in a subsequent step the isocyanate-reactive silane containing compound is introduced. When the isocyanate-reactivite substance contains a secondary amine, as with some of the silane compounds described above, it is necessary that the isocyanate reactive silane-containing moiety is first reacted with the prepolymer and then in a subsequent step the isocyanate-reactive substance containing the polymerizable moiety is introduced. Such a sequence of steps aids in avoiding reaction of an acrylate with the secondary aminosilanes by the Michael addition reaction, resulting in oligomers and eventually gelation.

When capping the isocyanate-terminated prepolymer with the isocyanate reactive substances it may be desirable to control the viscosity of the reactants, process or final adduct. This can be achieved by introducing a “reactive diluent” to the process. Such diluent can be introduced at any stage of the process. By the term “reactive diluent” it is understood a liquid substance which is able to undergo polymerization when exposed to the previously mentioned energy sources yet does not undergo reaction with the isocyanate-terminated prepolymer nor with the isocyanate-reactive substances. Exemplary of suitable reactive diluents are compounds comprising acrylate or methacrylate functionality and those characterized by absence of an isocyanate-reactive functionality. Preferred diluents include isoboranolacrylate (IBOA), tripropyleneglycoldiacrylate (TPGDA), N-vinyl pyrrolidone, isopropylacetate and dipropyleneglycoldiacrylate (DPGDA).

Preferably the amount of reactive diluent added is sufficient to give a viscosity of the final adduct solution of between 500 to 2,000 cps. HEMA may also be used as a reactive diluent. When HEMA is used, it is intuitively obvious that HEMA can not be used as a reactive diluent until after partial capping of the —NCO groups with the silane-containing moiety. After such capping, HEMA is then added at an excess so that all the remaining —NCO groups are capped and there is remaining unreacted HEMA to act as a diluent.

For addition of a functional group to the isocyanate-terminated prepolymer, the process temperature is chosen for convenience of reaction time and can be greater than 80° C. In general, exposure to a temperature greater than 100° C. should be minimized for the purpose of avoiding undesirable side reactions. The reaction of the isocyanate-terminated prepolymer with a polyfunctional substance can, if desired, be accelerated by use of a suitable urethane-promoting catalyst. Representative of such catalysts include tertiary amine compounds and organotin compounds as used when preparing, for example, polyurethane foam by reaction of a polyisocyanate with a polyol. It is to be noted that use of a catalyst can lead to final adducts having a higher viscosity than those prepared in the absence of catalyst.

The energy curable formulations for coating a substrate generally contains other compounds or additives in addition to the adduct of the present invention. Such compositions generally contain from 0.1 to 99 percent by weight of the adduct. Preferably the composition will contain from 10 to 75 percent by weight of the adduct. More preferred are compositions which contain from 15 to 60 percent by weight of the adduct. Such optional additives include light sensitive and light absorbing materials (including U.V. blockers), catalysts, initiators, lubricants, wetting agents, organofunctional silane or silicones, antioxidants and stabilizers.

A photoinitiator is usually required for a TV curable composition, while photoinitiators can usually be eliminated for an electron beam curable composition. The photoinitiator, when used in the composition to initiate radiation cure, provides reasonable cure speed without causing premature gelling of the composition. Examples of free radical photoinitiators are hydroxycyclohexylphenyl ketone, hydroxymethyl phenylpropanone, dimethoxyphenylacetophenone, 2-methyl-1-[4-(methylthio)-phenyl]-2-morpholinopropanone-1, 1-(4-isopropylphenyl)-2-hydroxy-2-methylpropane-1-one, 1-(4-dodecylphenyl)-2-hydroxy-2-methylpropan-1-one, 4-(2-hydroxyethyloxy)phenyl-2-(2-hydroxy-2-propyl)-ketone, diethoxyphenyl acetophenone, 2,4,6-trimethyl-benzoyl diphenylphosphine.

The present invention also encompasses an article comprising a substrate coated with a composition containing an adduct of the present invention in the cured state.

Yet another embodiment of this invention is that the incorporation of silane groups and the energy cured groups in the same adduct allows for coating formulations which can undergo moisture cure reaction and energy curing, simultaneously or sequentially, in either order, leading to an increased crosslink density, compared to materials with only energy cure mechanisms. This allow coatings where it is desired to increase hardness, solvent resistance and abrasion resistance of the coating.

It is of critical importance to avoid adding raw materials which have high residual acidity levels to formulations containing adducts of the present invention, for example, acrylic acid residues normally found in standard epoxy or polyether acrylates that have been produced by direct acrylation. The reason for this is that silane groups reaction is catalyzed by acidic groups. If this reaction occurs too soon, the formulation can have a short pot life and result in solidification or viscosity increase prior to use as a coating application.

The adducts of this invention have principle utility as a coating or additive to a coating formulation to coat substrates such as plastic, metal, natural textiles, synthetic textiles, minerals including glass and wood and wood products including paper where it is desirable to obtain adhesion to a surface.

The invention defined above will now be illustrated with reference to the following Examples.

### EXAMPLE I

### Preparation of Prepolymer

To a 2-liter glass reactor was added 798.2 grams of toluene diisocyanate (TDI) (VORANATE™ T-80, VORANATE is a trademark of The Dow Chemical Company) and 0.22 grams of benzoyl chloride. The mixture, under nitrogen, was heated to a stable temperature of 50° C. and then 690.1 grams of a 6-functional, 303 equivalent weight EO/PO polyol, 5.6 percent by weight OH, was added at a rate of 10 g/min. Digestion of the reaction mixture continued for 4 hours. After digestion the product was recovered. The recovered material was subjected to a short-path distillation under less than 0.05 mbar, 160° C. top, 70° C. bottom. The recovered isocyanate-terminated stripped prepolymer had a free TDI content of <0.1 weight percent and a measured NCO content of 8.6 weight percent

### Acrylate/Silane Capping

To a 500 ml three-neck round bottom flask, with stirring and heating, under nitrogen gas flow, at 60° C., was added 171.8 grams of the stripped prepolymer. After the prepolymer stabilized at 60° C., 60.1 grams of bis-[3-(trimethoxysilyl)propyl]amine (Silquest A-1170, Silquest is a Trademark of Witco) was added over a dosing time of 40 minutes. After about 30 minutes of further mixing 117.2 grams of tripropyleneglycoldiacrylate (TPGDA) was added.

The atmosphere within the flask was then changed to dry air. A mixture of 20.6 g of 2-hydroxyethylacrylate (HEA), 0.5 g Dabco T-12 (dibutyltindilaurate, Air Products) catalyst and 0.8 g of 4-methoxyphenol (MEHQ) was then added over a 10 minute period. After a further 80 minutes of mixing an infrared spectrum was taken and no peak for free NCO groups was observed. The final product (Sample A)had a measured free HEA content of <0.1 weight percent and a viscosity of 38,640 mPa.s (23° C.).

### EXAMPLE 2

### UV Curing Sample Preparation and Metal Adhesion Study

A composition (resin?) to test adhesion to a metal is given in Table 1. The componenets were added together in a glass jar and mixed to a homogeneous state. T 2011.01 is a developmental difunctional polyurethane acrylate resin available from The Dow Chemical Company. The T 2011.01 contains less than 0.1% diacrylate diisocyanate and is based on a nominal 3000 molecular weight polypropylene oxide polyether diol chain extended with TDI and HEA. The obtained resin was bar coated using Erichsen wound wire rods of a nominal wet coating thickness of between 10-200 microns (depending on testing requirements) on QD 46 smooth finish cold rolled steel Q-Panels™ (Trademark of Q-Panel) and on standard glass plates. The wet coated panel was immediately exposed to a 400 watt/inch UV source from a mercury vapor lamp by being placed on the conveyor belt of an American Ultraviolet Mini-conveyor at a belt speed of 10 m/min for a single pass. Wet coatings cured fully to a hard clear film after exposure. Samples were placed in controlled atmosphere as laid out in the appropriate test method.

TABLE 1
UV formulation composition

| | |
|---|---|
| Sample A (from Example 1) | 50 pbw |
| Teactive polymer T2011.01 | 20 pbw |
| TPGDA | 26 pbw |
| Photoinitiator Irgacure* 184 | 2 pbw |
| Photoinitiator Darocure 1173 | 2 pbw |

*Irgacure and Darocure are Trademarks of Ciba Speciality Chemicals.

### Coating Sample Testing Methods

1. Cross-Hatch Adhesion Test.

Adhesion to a metal surface was measured using ASTM D 3359-97 “Standard Test Methods for Measuring Adhesion by Tape Test”. An Erichsen Model 295 manual cross hatch cutter was used to produce the crosshatch pattern in the coatings. Coating thickness was 50 microns. Permacel 99 tape was used to adhere to the crosshatch pattern. The tape was rubbed down well onto the coating using medium pressure from the index finger. The tape was allowed to remain in contact with the coating for 1 minute. The tape was then pealed back at 180° angle from the coated substrate at a rapid constant rate. The amount of coating removed was judged and recorded. The test method then groups the percentage removal into 6 classes, as follows:

| | |
|---|---|
| 5B | 0% removed, that is 100% adhesion, no coating removed |
| 4B | less than 5% removed |
| 3B | 5-15% removed |
| 2B | 15-35% removed |
| 1B | 35-65% removed |
| 0B | More than 65% removed |

These groups 5B through 0B are recorded as the result

2. Pendulum Hardness

Hardness of a coating was measured using ASTM D 4366-95 “Standard Test Methods for Hardness of Organic Coatings by Pendulum Damping Tests”. The test used an Erichsen machine with Konig and Perzod Pendulums. The equipment has both geometry's and an electronic pendulum movement sensor and timer arrangement. In essence, both tests have a pendulum mounted on ball-bearings that contact the coating surface. The pendulums are of different weights. The Konig is much lighter and is used for hard coatings. The heavier Perzod pendulum is normally used on softer coatings as it can slip on hard surfaces. The ball-bearings indent the surface coating. As the pendulum is set rocking the degree of the indentation gives a damping factor, which reduces the arc of the pendulum swing with time. The time taken to reduce the arc of the pendulum between two fixed angles is reported in seconds for both Konig and Perzod. A coating thickness of 100 microns was used for this test.

3. Impact Deformation

A Gardner-SPI modified variable height impact tester (Model 172) equipped with a 2 lb weight and ½ inch diameter impact ball was used to assess impact resistance of UV cured coatings. The test method employed was ASTM D 2794-93 “Standard test method for Resistance of organic coatings to the effects of rapid deformation (Impact)”. In summary, the test specimen is placed horizontally on a support with the coating surface either face up or face down depending on whether intrusion or extrusion type impact is being determined. The weight is lifted in the guide tube above the specimen to a known height and released to free fall onto the specimen. The maximum height at which the coating surface does not crack or delaminate from the substrate is determined. The height of drop, impact weight, coating thickness, substrate type and thickness are all recorded.

4. Solvent Double Rub Test

The “Standard practice for assessing the solvent resistance of organic coatings using solvent rubs” (ASTM D 5402-93) was followed using acetone as the solvent. This method involves saturating a cloth in acetone and rubbing it back and forth on the coating using moderate pressure from the index finger. One motion back and forth should take one second and is counted as 1 double rub. The coating surface is observed during the test. At the first sign of failure (cracking, swelling, delamination) the test is stopped and the number of double rubs required for failure is recorded.

5. Dynamic Mechanical Spectroscopy (DMS)

A Rheometrics Solids Analyser RSA II was used on 100-200 micron coating films to obtain DMS plots. Samples were heated from −100° C. to 150° C. at 5° C./min heating rate in the test chamber, held in place using thin film tension mode fixture. A strain of 0.1 was utilized with a frequency of 1 Hz (6.28 rad/s).

### Results

As designed the formulation presented in Table 1 should have a dual cure mechanism. That is, the terminal acrylate groups within the resin are polymerised on exposure to the UV source to convert the wet coating to a dry film. A second reaction takes place over time, involving the silane groups of the Sample A resin. Thus the testing of the dry film coated Q-Panels was repeated over a period of 1 week The data in Table 2 indicates the test results 1 day after UV exposure and 1 week after exposure.

TABLE 2
Dry coat test results:

| Property | 1 Day old | 1 week old |
|---|---|---|
| Tg by DMS | 48° C. | 75° C. |
| Konig Hardness | 35 sec | 115 sec |
| Adhesion on QD-46 steel panel | 0B (20%) | 5B (100%) |
| Adhesion on glass panel | 0B (20%) | 5B (100%) |
| Acetone double rubs | >50 | >50 |
| Reverse Impact | >100 cm | >100 cm |

Clearly evident is the desired property of improved adhesion performance to both steel and glass panels. As expected, the glass transition temperature increases with time as the second silane reaction takes place. This also results in an improved hardness performance of the coating.

Although the invention has been described in detail in the foregoing for the purpose of illustration, it was to be understood that such detail was solely for that purpose and that variations can be made therein by those skilled in the art without departing from the spirit and scope of the inventions.

1. A liquid polyurethane-containing adduct wherein the adduct contains as a first functional group at least one structo-terminal polymerizable group and at least one second structo-terminal functional group per molecule which is a silane moiety.

2. The adduct of claim 1 wherein the adduct is derived from an NCO-terminated prepolymer containing less than 1 percent by weight of free isocyanate monomer.

3. The adduct of claim 1 wherein the adduct has 2 to 8 structo-terminal groups.

4. The adduct of claim 1 wherein the polymerizable group is selected from, vinyl ester, vinyl ether or acrylamide functionality.

5. The adduct of claim 4 wherein the polymerizable group is selected from acrylate or methacrylate.

6. The adduct of claim 1 wherein the molar ratio of polymerizable functional groups to silane moieties is 2:1 to 1:2.

7. An energy curable formulation for coating a substrate, wherein the formulation contains from 1 to 99 percent by weight of the adduct of any one of claim 1.

8. A process of coating a substrate surface comprising applying to the surface of a substrate a formulation of claim 7 and in a subsequent step, exposing the treated surface to an energy source to induce polymerization of the formulation.

9. The process of claim 8 wherein the energy source is actinic radiation, ultraviolet radiation, electron-beam radiation or thermal radiation.

10. An article prepared by the process of claim 9.

11. A method for making an adduct containing at least one structo-terminal polymerizable group and at least one structo-terminal silane group comprising the steps of
(1) mixing a polyol containing isocyanate reactive groups with a polyisocyante at a stoichiometric excess of isocyanate groups to isocyanate groups to form an isocyanate terminated prepolymer;
(2) mixing the prepolymer obtained from step 1 with an isocyanate-reactive compound containing a polymerizable moiety wherein the number of isocyanate-reactive moieties is less than a stoichiometric amount with respect to the isocyanate moieties present on the prepolymer;
(3) mixing the product from step 2 with an isocyanate-reactive compound containing a silane moiety where the stoichiometric amount of isocyanate-reactive groups is at a slight excess with respect to the number of free isocyanate groups remaining after step 2; and
(4) recovering the product from step 3.

12. The process of claim 11 wherein the isocyanate-reactive compound containing a silane moiety is added in step 2 and the isocyanate-reactive compound containing a polymerizable groups is added in step 3.

13. The process of claim 11 wherein the amount of free polyisocyanate monomer present after step 1 is less than 1 percent of the total prepolymer or the amount of free polyisocyanate monomer present is reduced to less than 1 percent by weight of the prepolymer prior to step 2.

14. The process of claim 13 wherein the polymerizable group is vinyl ester, vinyl ether or acrylamide functionality.
